(19) United States
(12) Patent Application Publication
(10) Pub. No.: US 2004/0032756 A1
(43) Pub. Date: Feb. 19, 2004

(54) Transformerless AC/DC converter

(75) Inventor: Luc Jozef Louis Van Den Bossche, Lebbeke (BE)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: STMicroelectronics N.V., Amsterdam (NL)

(21) Appl. No.: 10/387,119

(22) Filed: Mar. 12, 2003

(30) Foreign Application Priority Data
Mar. 12, 2002 (EP) 02290613.5

(51) Int. Cl. H02M 7/00

(52) U.S. Cl. 363/125

(57) ABSTRACT

AC/DC converters comprise rectifiers for rectifying AC signals into DC signals. By providing these AC/DC converters with voltage dividing capacitors located between converter-input, a resistor, added to voltage dividing capacitor for filtering peak signals, and a rectifier, the rectifier can be better integrated, as it no longer receives the entire input voltage present at the converter-input of the AC/DC converter, without a conventional transformer comprising an iron core and windings being required. Such an AC/DC-converter is small sized, of light-weight and low costly made. Preferably, the converter-input is symmetric, the rectifier comprises two diodes and two transistors and a zero-cross detector for switching the transistors, the AC/DC converter comprises a down-converter located between the rectifier and converter-output for further down-converting purposes and comprising an inductor and a regulator for regulating inductor/capacitor-energies, with buffer capacitors being present in parallel to the down-converter for stabilising purposes, to get a transformerless wall plug adapter.

### CROSS-REFERENCE TO RELATED APPLICATIONS

This application is based upon and claims priority from prior European Patent Application No. 02290613.5, filed on Mar. 12, 2002, the entire disclosure of which is herein incorporated by reference.

### BACKGROUND OF THE INVENTION

1. Field of the Invention

The present invention is related to an AC/DC converter comprising a converter input for receiving an AC signal, a converter output for generating a DC-signal and a rectifier coupled to said converter input for rectifying said AC-signal.

Such an AC/DC converter is for example a portable charger or an adapter for converting for example a 220 Volt [mains] or an AC signal to for example a 5 Volt DC signal or a 3 Volt DC signal.

2. Description of the Prior Art

A prior art AC/DC converter is known from U.S. Pat. No. 5,805,436, which comprises said rectifier coupled to said converter input and capacitors coupled to said converter output and located between said rectifier and said converter output for converting a high input voltage and a low input current to a low output voltage and a high output current.

The known AC/DC converter is disadvantageous, inter alia, because it cannot be used in combination with certain chip technologies, which cannot handle input voltages exceeding 100 Volt.

In the AC/DC converter in prior art document EP 0 317 783 two capacitors are connected in parallel with the AC voltage source, whereby the second capacitor is in parallel with a load, typically a DC motor, via a rectifier.

The invention disclosed in prior art document GB 2 175 463 A also uses capacitors to limit the current and voltage of loads. No precautions are taken for filtering incoming peak voltage signals.

Accordingly, a need exists to over come the problems with the prior art and to provide an AC/DC converter, which can be integrated to a large(r) extent without thereby requiring too limited values of possible input voltages.

### SUMMARY OF THE INVENTION

The AC/DC-converter according to the invention is characterised in that said AC/DC-converter comprises at least two serial voltage dividing capacitors, of which a first capacitor is coupled in parallel to an input of said rectifier, and of which a second capacitor is located between said converter input and said first capacitor. It further comprises a first resistor coupled serially to said second capacitor and located between said converter input and said first capacitor.

By introducing said first and second voltage dividing capacitors, a voltage divider has been created, thereby allowing the rectifier to be integrated without being required to limit the value of possible input voltages, due to said voltage divider taking care of a voltage reduction. By additionally introducing said first resistor, the combination of this first resistor and said second capacitor forms a filter for filtering peak signals, like peak voltages of for example 1 kV appearing during for example 1 μs.

The invention is based upon an insight, inter alia, that a voltage divider in the form of a conventional transformer comprising an iron core and primary and secondary windings is heavy and inconvenient, and is based upon a basic idea that such a voltage divider can be replaced by a voltage divider in the form of impedances.

The invention solves the problem of providing a transformerless AC/DC converter which can be integrated to a larger extent, and is advantageous, inter alia, due to its small size, light weight and low cost.

It should firstly be noted that the AC/DC converter according to the invention does not need to comprise a conventional transformer having an iron core and windings. The AC/DC converter according to the invention is not limited to transformerless AC/DC converters. In combination with said voltage dividing capacitors, conventional transformers can still be used.

It should secondly be noted that the AC/DC converter according to the invention can be integrated according to certain chip technologies which cannot handle input voltages exceeding 100 Volt. The AC/DC converter according to the invention is however not limited to these chip technologies. Further the AC/DC converter may be integrated to a less extent or not at all.

It should thirdly be noted that the AC/DC converter according to the invention can also be used for lower input voltages not forming any threat to certain chip technologies. The AC/DC converter according to the invention can also be used for other input signals, like currents. The AC/DC converter according to the invention can also generate other output signals, like currents. For example in case of receiving an input signal in the form of a current, the voltage dividing capacitors will protect the rectifier against additional (offset) voltages present at the converter input.

A first embodiment of the AC/DC converter according to the invention is advantageous in that said converter input comprises a first input terminal and a second input terminal, with said first input terminal being coupled via a first serial circuit to a parallel circuit, and with said second input terminal being coupled via a second serial circuit to said parallel circuit, with said first serial circuit comprising said second capacitor and said first resistor, and with said parallel circuit comprising said first capacitor and said rectifier, and with said second serial circuit comprising a third capacitor and a second resistor.

By introducing said first and second serial circuits, the converter input is symmetric and can be used in countries not having unreversable mains connections.

A second embodiment of the AC/DC converter according to the invention is advantageous in that said rectifier comprises two diodes and two transistors.

By introducing said rectifier having two diodes in the positive branch and two transistors in the negative branch, it becomes possible to integrate the (bridge) rectifier together with the other circuitry into one single integrated circuit. The transistors (switches) in the negative branch avoid having negative voltages on board of the integrated circuit below minus 0.5 Volt.

A third embodiment of the AC/DC converter according to the invention is advantageous in that said rectifier comprises a zero-cross detector for switching said transistors.

By introducing said zero-cross detector, which itself is of common general knowledge, both transistors can be controlled in such a way that the maximum output voltage of said rectifier is limited.

A fourth embodiment of the AC/DC converter according to the invention is advantageous in that said AC/DC converter comprises a down-converter coupled to an output of said rectifier and said converter-output.

By introducing said down-converter, the output voltage of said rectifier can be down-converted. Thereby it should be noted that this down-converter introduces a second down-converting stage, in view of said voltage dividing capacitors being a first down-converting stage. So, the AC/DC converter according to the invention and according to the fifth embodiment comprises at least two down-converting stages, with the second down-converting stage (and possibly further down-converting stages) being optional.

A fifth embodiment of the AC/DC converter according to the invention is advantageous in that said AC/DC converter comprises a first buffer capacitor coupled in parallel to the output of said rectifier and to an input of said down-converter.

By introducing said first buffer capacitor, the output voltage of said rectifier being an input voltage for said down-converter is stabilised.

A sixth embodiment of the AC/DC converter according to the invention is advantageous in that said AC/DC converter comprises a second buffer capacitor coupled in parallel to an output of said down-converter.

By introducing said second buffer capacitor, the output voltage of said down-converter being an output voltage of said AC/DC converter is stabilised.

A seventh embodiment of the AC/DC converter according to the invention is advantageous in that said down-converter comprises an inductor and a regulator for regulating an inductor energy and a second buffer capacitor energy.

By introducing said inductor and said regulator, a simple, low cost, less complex down-converter has been created, of which said regulator can be entirely integrated, possibly together with said rectifier.

The invention also relates to an transformerless wall plug adapter, which is characterised in that it comprises an AC/DC converter as defined hereabove.

Such a transformerless wall plug adapter is made low costly, of little weight and small sized, with a largest part (for example comprising a rectifier+down-converter excluding the inductor) being integrated and with a smaller part (for example comprising capacitors, resistors, inductor) being added in the form of external components.

It should fourthly be noted that when in the AC/DC converter according to the invention two or more parts are coupled, they may be connected directly to each other or they may be connected indirectly to each other via a third part. When a fourth part is located between a fifth and a sixth part, this fourth part may be connected directly to said fifth and/or sixth part, or this fourth part may be connected indirectly to said fifth and/or sixth part via a seventh and/or eighth part etc.

It should fifthly be noted that in the AC/DC converter according to the invention an AC signal may further comprise a DC component, like for example an offset, and a DC signal may further comprise an AC component, like for example noise.

These and other aspects of the invention will be apparent from and elucidated with reference to the embodiments(s) described hereinafter.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention will be apparent from the following detailed description taken in conjunction with the accompanying drawings.

FIG. 1 illustrates in block diagram form an AC/DC-converter according to the invention comprising serial voltage dividing capacitors, a rectifier and a down-converter.

FIG. 2 illustrates in block diagram form a rectifier for use in said AC/DC converter according to the invention.

### DETAILED DESCRIPTION OF THE INVENTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

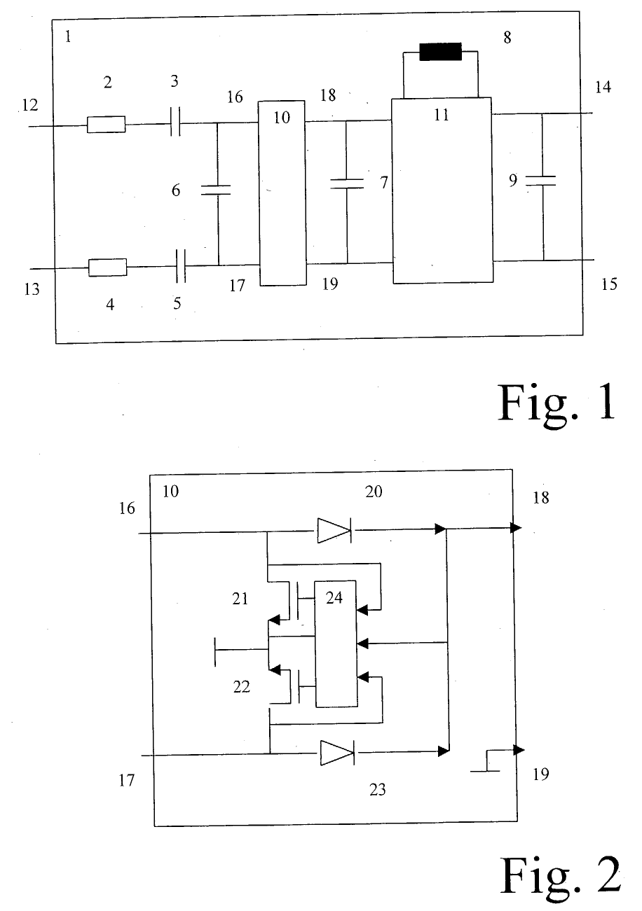

FIG. 1 illustrates an AC/DC converter 1 comprising a converter-input 12,13 having a first input terminal 12 and a second input terminal 13, a rectifier 10 and a down-converter 11. Rectifier 10 comprises an input 16,17 and an output 18,19, with a first capacitor 6 being coupled in parallel to (said input 16,17 of) said rectifier 10, and with a first buffer capacitor 7 being coupled in parallel to (said output 18,19 of) said rectifier 10 and to an input of said down-converter 11. An output of down-converter 11 is coupled to a converter output 14,15, with a second buffer capacitor 9 being coupled in parallel to said output of said down-converter 11. Down-converter 11 comprises (or is coupled to) an inductor 8 and comprises a regulator not shown. Input 16,17 of rectifier 10 comprises a first input connection 16 and a second input connection 17. Input connection 16 is coupled via a second capacitor 3 and a first resistor 2 to said first input terminal 12, and input connection 17 is coupled via a third capacitor 5 and a second resistor 4 to said second input terminal 13.

FIG. 2 illustrates a rectifier 10 with input connections 16,17 and with output connections 18,19. Input connection 16 is coupled to an anode of a diode 20 and to a first serial path electrode (drain) of a MOSFET transistor 21 and to a first input of a zero-cross detector 24. A cathode of diode 20 is coupled to output connection 18 and to a second input of zero-cross detector 24. Input connection 17 is coupled to an anode of a diode 23 and to a first serial path electrode (drain) of a MOSFET transistor 22 and to a third input of a zero-cross detector 24. A cathode of diode 23 is coupled to said output connection 18 and to said second input of zero-cross detector 24. Output connection 19, zero-cross detector 24 and second serial path electrodes (sources) of transistors 21 and 22 are coupled to ground. A first output of zero-cross detector 24 is coupled to a control electrode (gate) of transistor 21, and a second output of zero-cross detector 24 is coupled to a control electrode (gate) of transistor 22.

AC/DC converter 1 as shown in FIG. 1 is for example a portable charger or an adapter for converting for example a 220 Volt mains or an AC signal to for example a 5 Volt DC signal or a 3 Volt DC signal. It comprises converter input 12,13 for receiving an AC signal and converter output 14,15 for generating a DC signal and rectifier 10 coupled to said converter input 12,13 for rectifying said AC signal.

AC/DC converter 1 further comprises three serial voltage-dividing capacitors 6,3,5, which together form a voltage divider. This allows rectifier 10 to be integrated without being required to limit the value of possible input voltages, due to said voltage divider taking care of a voltage reduction.

Resistors 2,4 respectively form in combination with capacitors 3,5 respectively filters for filtering peak signals, like peak voltages of for example 1 kV appearing during for example 1 μs.

The converter-input 12,13 is symmetric and can be used in countries not having unreversable mains connections.

Rectifier 10 as shown in FIG. 2 comprises two diodes 20,23 and two MOSFET transistors 21,22. Due to having two diodes 20,23 in the positive branch and having two transistors 21,22 in the negative branch, the (bridge) rectifier 10 can be integrated together with the other circuitry into one single integrated circuit. The transistors (switches) 21,22 in the negative branch avoid to have negative voltages on board of the integrated circuit below minus 0.5 Volt.

Rectifier 10 further comprises a zero-cross detector 24 for switching said transistors. This zero-cross detector 24 is itself is of common general knowledge and allows both transistors 21,22 to be controlled in such a way that the maximum output voltage of said rectifier 10 is limited.

AC/DC converter 1 as shown in FIG. 1 further comprises down-converter 11 coupled to an output 18,19 of said rectifier 10 and said converter output 14,15.

By introducing said down-converter 11, the output voltage of said rectifier 10 can be down-converted. Thereby it should be noted that this down-converter 11 introduces a second down-converting stage, in view of said voltage dividing capacitors 6,3 being a first down-converting stage. So, AC/DC converter 1 as shown in FIG. 1 comprises at least two down-converting stages, with the second down-converting stage (and possibly further down-converting stages) being optional.

AC/DC converter 1 further comprises first buffer capacitor 7 coupled in parallel to the output 18,19 of said rectifier 10 and to an input of said down-converter 11 for stabilising the output voltage of said rectifier 10 being an input voltage for said down-converter 11, and comprises second buffer capacitor 9 coupled in parallel to an output of said down-converter 11 for stabilising the output voltage of said down-converter 11 being an output voltage of said AC/DC converter 1.

Finally AC/DC converter 1 further comprises an inductor 8 and a regulator for regulating an inductor energy and a second buffer capacitor energy. Of such a simple, low cost, less complex down-converter 11, said regulator can be entirely integrated, possibly together with said rectifier 10.

Said zero-cross detector 24 is of common general knowledge and for example comprises a first operational amplifier of which the inputs are coupled to said first and third input of said zero-cross detector, and for example further comprises two serial resistors located between said second input of said zero-cross detector and ground, with a common point of these serial resistors being coupled to a first input of a second operational amplifier, of which second operational amplifier a second input is coupled to a reference source. Outputs of both operational amplifiers are each coupled to inputs of two gate circuits, of which two gate circuits the outputs are coupled to the outputs of said zero-cross detector 24. Said gate circuits are for example so-called NANDs.

Said regulator in down-converter 11 for example comprises two MOSFET transistors of which the control electrodes (gates) are coupled to each other and to an output of a first gate circuit, for example a so-called inverter, and of which two transistors the first serial path electrodes (drains) are coupled to each other and to a first input connection of down-converter 11, with a second input connection being coupled to ground. A second main electrode (source) of one of said transistors is coupled to a first input of a first operational amplifier and to one side of a resistor, of which resistor the other side is coupled to the second main electrode (source) of the other transistor, to one side of inductor 8, to a first serial path electrode (drain) of a third MOSFET transistor and to a second input of said first operational amplifier via a reference source. A control electrode (gate) of said third transistor is coupled to an output of a flipflop and to an input of said first gate circuit, and a second main electrode (source) of said third transistor is coupled to ground. The other side of said inductor 8 forms a first output connection of down-converter 11, with a second output connection of down-converter 11 being coupled to ground. This other side of inductor 8 is coupled to one side of buffer capacitor 9, of which the other side is coupled to ground. This other side of inductor 8 is coupled to one side of two serial resistors, of which two serial resistors the other side is coupled to ground and of which two serial resistors a common point is coupled to a first input of a second operational amplifier, of which a second input is coupled to a reference source and of which an output is coupled to a first input of a second gate circuit, like for example a so-called OR, of which second gate circuit a second input is coupled to an output of said first operational amplifier and of which second gate circuit an output is coupled to an input of said flip flop.

Of course, many alternatives are possible, especially but not exclusively with respect to said zero-cross detector 24 and said regulator, without departing from the scope of this invention. For example instead of MOSFET transistors, other transistors like bipolar transistors could be used.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. An AC/DC converter comprising:
a converter-input for receiving an AC signal;
a converter output, for generating a DC signal; and
a rectifier coupled to the converter input for rectifying the AC signal;
wherein the AC/DC converter includes at least two serial voltage dividing capacitors, of which a first capacitor is coupled in parallel to an input of the rectifier, and of which a second capacitor is coupled between that converter input and the first capacitor; and
wherein the AC/DC converter comprises a first resistor coupled serially to the second capacitor and the first resistor is coupled between the converter input and the first capacitor.

2. The AC/DC converter according to claim 1, wherein the converter-input further comprises:
a first input terminal and a second input terminal, with the first input terminal being coupled via a first serial circuit to a parallel circuit, and with the second input terminal being coupled via a second serial circuit to the parallel circuit;
wherein the first serial circuit includes the second capacitor and the first resistor; and
wherein the parallel circuit includes the first capacitor and the rectifier, and with the second serial circuit comprising a third capacitor and a second resistor.

3. The AC/DC converter according to claim 1, wherein the rectifier comprises two diodes and two transistors.

4. The AC/DC converter according to claim 3, wherein the rectifier comprises a zero-cross detector for switching the transistors.

5. The AC/DC converter according to claim 1, wherein the AC/DC converter comprises a down-converter coupled to an output of the rectifier and the converter-output.

6. The AC/DC converter according to claim 5, wherein the AC/DC converter comprises a first buffer capacitor coupled in parallel to the output of the rectifier and to an input of the down-converter.

7. The AC/DC converter according to claim 6, wherein the AC/DC converter comprises a second buffer capacitor coupled in parallel to an output of the down-converter.

8. The AC/DC converter according to claim 7, wherein the down-converter comprises an inductor and a regulator for regulating an inductor energy and a second buffer capacitor energy.

9. A transformerless wall plug adapter, comprising:
an AC/DC converter including:
a converter-input for receiving an AC signal;
a converter output, for generating a DC signal; and
a rectifier coupled to the converter input
for rectifying the AC signal;
wherein the AC/DC converter includes at least two serial voltage dividing capacitors, of which a first capacitor is coupled in parallel to an input of the rectifier, and of which a second capacitor is coupled between that converter input and the first capacitor; and
wherein the AC/DC converter comprises a first resistor coupled serially to the second capacitor and the first resistor is coupled between the converter input and the first capacitor.

10. The transformerless wall plug adapter of claim 9, wherein the A/C signal received is one of 220 Volts and 110 Volts.

11. The transformerless wall plug adapter of claim 9, wherein the converter-input further comprises:
a first input terminal and a second input terminal, with the first input terminal being coupled via a first serial circuit to a parallel circuit, and with the second input terminal being coupled via a second serial circuit to the parallel circuit;
wherein the first serial circuit includes the second capacitor and the first resistor; and
wherein the parallel circuit includes the first capacitor and the rectifier, and with the second serial circuit comprising a third capacitor and a second resistor.

12. The transformerless wall plug adapter of claim 9, wherein the rectifier comprises two diodes and two transistors.

13. The transformerless wall plug adapter of claim 12, wherein the rectifier comprises a zero-cross detector for switching the transistors.

14. The transformerless wall plug adapter of claim 9, wherein the AC/DC converter comprises a down-converter coupled to an output of the rectifier and the converter-output.

15. The transformerless wall plug adapter of claim 14, wherein the AC/DC converter comprises a first buffer capacitor coupled in parallel to the output of the rectifier and to an input of the down-converter.

16. The transformerless wall plug adapter of claim 15, wherein the AC/DC converter comprises a second buffer capacitor coupled in parallel to an output of the down-converter.

17. The AC/DC converter according to claim 16, wherein the down-converter comprises an inductor and a regulator for regulating the inductor and a second buffer capacitor energy.

18. The transformerless wall plug adapter of claim 17,
wherein the inductor and regulator are integrally formed with the rectifier.
